(19) United States
(12) Patent Application Publication
(10) Pub. No.: US 2023/0206675 A1
(43) Pub. Date: Jun. 29, 2023

(54) SYSTEMS AND METHODS FOR INFORMATION RETRIEVAL AND EXTRACTION

(71) Applicant: DataInfoCom USA, Inc, Austin, TX (US)

(72) Inventor: Wensu Wang, Katy, TX (US)

(21) Appl. No.: 18/070,308

(22) Filed: Nov. 28, 2022

Related U.S. Application Data
(63) Continuation-in-part of application No. 17/837,017, filed on Jun. 9, 2022.
Application No. 17/837,017 is a continuation-in-part of application No. 17/063,661, filed on Oct. 5, 2020.
Application No. 17/063,661 is a continuation-in-part of application No. 16/732,281, filed on Dec. 31, 2019.
Application No. 16/732,281 is a continuation-in-part of application No. 17/491,361, filed on Sep. 30, 2021.
(60) Provisional application No. 62/976,191, filed on Feb. 13, 2020.
(60) Provisional application No. 63/085,963, filed on Sep. 30, 2020.

(51) Int. Cl. G06V 30/416; G06V 30/42; G06V 30/22; G06F 40/40

(52) U.S. Cl. CPC G06V 30/416; G06V 30/42; G06V 30/22; G06F 40/40

(57) ABSTRACT

To extract necessary information, documents are received and classified, converted to text, and stored in a database. A request for information is then received, and relevant documents and/or document passages are selected from the stored documents. The needed information is then extracted from the relevant documents. The various processes use one or more artificial intelligence (AI), image processing, and/or natural language processing (NLP) techniques as well as knowledge-based and rule-based techniques.

### CROSS-REFERENCE TO RELATED APPLICATIONS

The present application is a continuation-in-part of U.S. patent application Ser. No. 17/837,017, entitled “SYSTEMS AND METHODS FOR PROCESSING CLAIMS,” filed Jun. 9, 2022, which is a continuation-in-part of U.S. patent application Ser. No. 17/063,661, entitled “SYSTEMS AND METHODS FOR PROCESSING CLAIMS,” filed Oct. 5, 2020, which is a continuation-in-part of U.S. patent application Ser. No. 16/732,281, entitled “SYSTEMS AND METHODS FOR CLAIMS PROCESSING,” filed Dec. 31, 2019, and claims the benefit of U.S. Provisional Patent Application No. 62/976,191, filed Feb. 13, 2020, and is a continuation-in-part of U.S. patent application Ser. No. 17/491,361, entitled “SYSTEMS AND METHODS FOR INFORMATION RETRIEVAL AND EXTRACTION,” filed Sep. 30, 2021, which claims the benefit of U.S. Provisional Patent Application No. 63/085,963, filed Sep. 30, 2020, each of which is hereby incorporated by reference herein in its entirety.

### BACKGROUND

This specification generally relates to extracting information from documents and more specifically to using image processing, natural language processing, and artificial intelligence techniques to convert any type of document (e.g., table, form, text, pdf, image, handwritten or machine-printed, etc.) to a computer-readable digital form and extract needed information from it.

### SUMMARY

In accordance with the foregoing objectives and others, exemplary methods and systems are disclosed herein for retrieving and extracting information from documents. Documents are received, converted to text, and stored in a database. A request for information is then received, and relevant documents and/or document passages are selected from the stored documents. The needed information is then extracted from the relevant documents. The various processes use one or more artificial intelligence (AI), image processing, and/or natural language processing (NLP) techniques, as described in more detail herein.

An embodiment comprises a computer-implemented method for extracting information from a set of computer-readable digital documents, comprising: classifying the documents into different domain classes; converting the digital documents to an image format; classifying each document as machine-printed, handwritten, or mixed; classifying each machine-printed or handwritten document as form-like or free-style; converting at least a portion of each document into a digital text format using one or more of a trained machine learning model and an optical character recognition algorithm, the conversion based on the document classification; and extracting information from the set of converted documents.

Another embodiment comprises a computer-implemented method for extracting information from a form-like mixed document, the document comprising pairs of prompts and responses, the method comprising: generating reference sentences based on the document prompts; associating each reference sentence with one or more data points; splitting the mixed document into segments, wherein each segment comprises a machine-printed prompt and a handwritten response; further splitting the segments into prompt segments and response segments; converting the prompt segments into text; generating similarity scores between the reference sentences and the converted prompt segments; and determining the value for at least one of the one or more data points based at least in part on the similarity scores and the associations between the reference sentences and the one or more data points.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for information retrieval and information extraction.

FIG. 2 illustrates an example information retrieval and information extraction module.

FIG. 3 illustrates an example method for information retrieval and information extraction.

FIG. 4 illustrates an image file with both machine-printed and hand-written text.

FIG. 5 illustrates an example method for information retrieval.

FIG. 6 illustrates an example method for converting images of text (either handwritten or machine-printed) into text.

FIG. 7 illustrates an example method for converting hybrid machine-printed and handwritten documents to text.

FIG. 8 illustrates an embodiment of a handwriting recognition model.

FIG. 9 illustrates an embodiment of a text classification model.

FIG. 10 illustrates an example method for information retrieval using a question-and-answer system.

FIG. 11 illustrates an example method for extracting data from a machine-printed form-like document.

FIG. 12 illustrates an example method for extracting information from a machine-printed free-style document.

FIG. 13 illustrates another example method for extracting information from a machine-printed free-style document.

FIG. 14 illustrates an example method for extracting information from a converted hybrid document.

FIG. 15 illustrates an example method for extracting date information from a document.

FIG. 16 illustrates another example method for extracting date information from a handwritten document.

FIG. 17 illustrates an example method for identifying a specific date data point from extracted date information.

### DETAILED DESCRIPTION

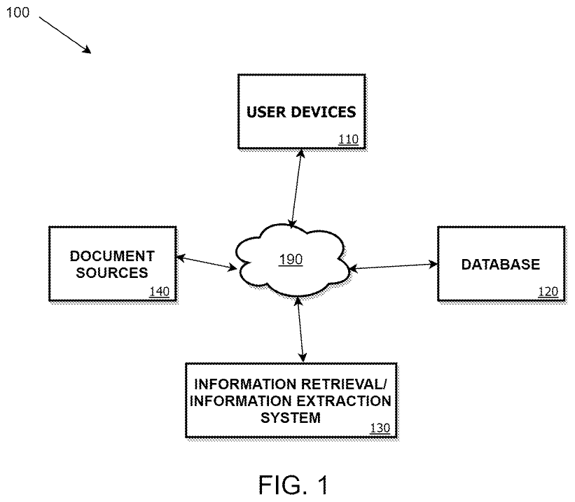

Referring to FIG. 1, a block diagram of an exemplary system 100 for use in information retrieval and information extraction is illustrated. The information retrieval system may include user devices 110, a database 120, an information retrieval and information extraction (IR/IE) system 130, and may receive input from document sources 140. The user devices, database, IR/IE system, internal devices, and external devices may be remote from each other and interact through communication network 190. Non-limiting examples of communication networks include local area networks (LANs), wide area networks (WANs) (e.g., the Internet), etc.

In certain embodiments, a user may access the information retrieval system 130, database 120, and/or document sources 140 via a user device 110 connected to the network 190. A user device 110 may be any computer device capable of accessing any relevant resource, system, or database, such as by running a client application or other software, like a web browser or web-browser-like application.

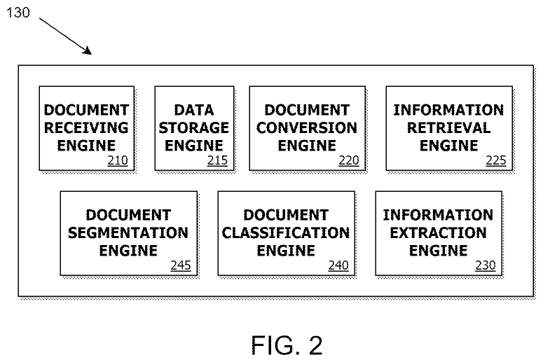

The information retrieval and information extraction system 130 is adapted to receive documents from document sources 140 and retrieve documents from database 120, convert received or retrieved documents to text (or another common format), and extract information from the converted documents. FIG. 2 is a more detailed schematic illustration of one example of an information retrieval and extraction system 130. As illustrated, the information retrieval and information extraction system includes a document receiving engine 210, a data storage engine 215, a document conversion engine 220, a document classification engine 240, a document segmentation engine 245, an information retrieval engine 225, and an information extraction engine 230. These engines are configured to communicate with each other to manage the entire process of receiving documents, document storage, document classification, document segmentation, document conversion, information retrieval, and information extraction.

Document receiving engine 210 is configured to receive documents of any sort from document sources 140. Documents received may include text documents, word processing documents, pdf documents, images, and scanned documents, including scanned machine-typed or machine-printed documents, scanned handwritten documents, and scanned documents with a mix of machine-printed and handwritten content.

Data storage engine 215 is configured to store the documents received by document receiving engine 210 into database 120. Data storage engine 215 is also configured to store documents converted by document conversion engine 220 and outputs from information retrieved and extracted from documents by information retrieval engine 225 and information extraction engine 230 into database 120. Data storage engine 215 can also be configured to store data in either structured or unstructured format, or both, depending on the type of documents and data received from document receiving engine 210.

Document classification engine 240 is configured to classify documents based on document metadata, document characteristics, and any other data related to or associated with documents. Documents may be classified using multiple different classification schemes, such as document domain (e.g., financial documents, medical documents, etc.), document text layout (free-style, form-like, etc.), document text type (machine-printed, handwritten, mixed, etc.), and others. Document classification engine 240 is also be configured to classify individual document segments (e.g., machine-printed segments, handwritten segments, free-style segments, form-like segments, etc.) generated by the document segmentation engine 245.

Document segmentation engine 245 segments documents using one or more trained machine learning model or other methods. This engine can process documents prior to them being converted to text, for example, to segment documents containing both handwritten and machine-printed segments. The engine can also process documents after they have been converted to text, for example, when segments may be identified by specific text labels. For example, a list of keywords based on domain knowledge can be created and used to identify the start or end of a segment, such as segments in an individual tax return form. The converted texts can then be compared with these keywords to determine the start or end of a segment using a similarity measure between the keywords and the words of the document.

In an embodiment, a set of blank horizontal whitespace or blank vertical whitespace can be used to identify the start or end of a segment in both converted and non-converted documents.

In an embodiment, a line or row with a specified characteristic, e.g., a text format (e.g., font, font size, whether bold or italic, etc.), a specific combination or distribution of types of characters, etc., may be identified as the start or end of a segment. For example, a row containing all words without numbers may be identified as a header of an embedded table in the converted document. The successive rows with another specified text format, such as containing mixed words and numbers, may be identified as the contents of the table until the second format is not present in the next row. As another example, a list can be identified by a leading character, such as a, b, c, 1, 2, 3, bullet points, etc., its position, and/or the amount of space between it and the following content.

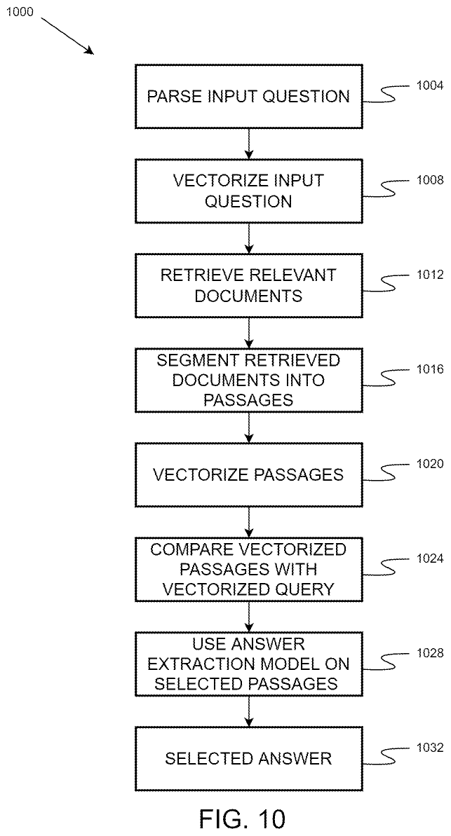

In an embodiment, a question answering technique may be used to identify segments. An example of a question-and-answer system is described with respect to FIG. 10.

In an embodiment, each word and/or element on the page may be associated with words and elements within a specified proximity based on the position and the dimensions of the word or element on the page and the distance to surrounding words and/or elements. Each collection of words and/or elements can be considered an individual segment.

In all document segmentations techniques for documents with a visual aspect (e.g., images, pdf files, scanned document, word processing document, etc.), the positional relationships of the converted segments can be maintained, e.g., a bounding box including x and y coordinates of the bounds of the segments (e.g., one or more of the upper-left, upper-right, lower-left, and lower-right corners of the segment). This retains useful context information, which can be used by the information extraction engine 230 when extracting data.

Document conversion engine 220 is configured to convert documents and/or document segments into a format that is interpretable by the information retrieval and information extraction engines. In an embodiment, all documents and document segments are converted, through one or more processes, to text format. For example, a pdf document may be converted to text by extracting the embedded format structure of text objects or by converting the document to images then using optical character recognition (OCR) techniques. Similarly, a scanned machine-printed document in image format may be converted to text using OCR techniques or other image processing as well as AI techniques.

Handwritten documents may be converted to text using deep learning and/or machine learning techniques to build a handwriting recognition model, e.g., comprising one or more trained neural networks.

In some embodiments, custom OCR and/or handwriting recognition modules may be used or generated that are specifically trained to recognize the words or language used in the applicable field, e.g., medical OCR and handwriting recognition modules, financial OCR and handwriting recognition modules, etc.

For documents containing both machine-printed portions and handwritten portions, in one embodiment the machine-printed and handwritten contents are separated into segments by document segmentation engine 245, then processed using machine learning models trained to recognize each different kind of writing (e.g., handwritten, machine-printed, etc.). Alternatively, the trained models for separate kinds of writing may be integrated as one model (e.g., they may be combined in series or in parallel) or may be used to train a unified text recognition model. For example, one specific way the trained models could be integrated is to create a top layer that identifies the type of writing present, handwritten or machine-printed, then sends the image segments to the appropriate model.

Documents converted by the document conversion engine 220 also include audio and video files, e.g., audio recordings of phone calls, video recordings of video calls, video chats, etc. After documents are converted to the desired format, e.g., text format, relevant information can be retrieved by the information retrieval engine 225 and extracted by the information extraction engine 230.

Information retrieval engine 225 is configured to search for all converted-to-text documents and/or document segments that are related to the information to be extracted. The methods used for information retrieval can be knowledge-based (e.g., if financial information is needed, documents containing solely medical information, such as doctor's notes, do not need to be retrieved, but tax return documents would be retrieved—this can be done using the classified document type output from document classification engine 240), rule-based (e.g., identifying documents based on a pre-defined set of rules), keyword-based (e.g., identifying documents based on keyword matching), machine-learning model-based (e.g., using a trained neural network to identify documents), among other possibilities.

In an embodiment, a transfer learning model, based on pre-trained information retrieval, can be used to efficiently build a retrieval model for document retrieval from a customized document database.

Information extraction engine 230 uses natural language processing (NLP) techniques to extract the required information from the converted-to-text documents selected by information retrieval engine 225. Such techniques may include text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, trained or pre-trained transfer learning, question-and-answer systems, etc.

Knowledge-based methods can also be used for information extraction from specific types of documents. For example, for an individual tax return form, first the form can be segmented into several parts based on keywords present in the document for each section, and then every item in each section is converted to text and compared with pre-defined keywords that are required to be extracted, and items are selected as intended information based on the comparison result. The comparison can include various text analytic and neutral language processing methods, such as to compare characters in the words or the semantic meaning of the words.

In any of the disclosed embodiments and methods, the extracted information can be associated with a confidence score. The score may be calculated in various ways depending on the type of model. Some types of models automatically output confidence scores with the extracted information. Alternatively, a probability value, similarity score, and/or a precision value may be returned with the extracted information.

To improve the accuracy of information extraction, human intervention can be integrated within the information extraction process. For example, whenever any calculated confidence score with respect to extracted information is low, human intervention may be requested, allowing a person to validate and/or update the result.

A low confidence score can also be associated with an indication of the reason for the low confidence (e.g., 1) incomplete or missing information; 2) inconsistent information; 3) unclear information; 4) calculation verification required, etc.), allowing the person to identify and address the specific reason for the low confidence score. Any human input to the information extraction engine in response to a low confidence score can be used as a labeled data point to re-train the engine and improve its accuracy.

Modifications, additions, or omissions may be made to the above systems without departing from the scope of the disclosure. Furthermore, one or more components of the systems may be separated, combined, and/or eliminated. Additionally, any system may have fewer (or more) components and/or engines. Furthermore, one or more actions performed by a component/engine of a system may be described herein as being performed by the respective system. In such an example, the respective system may be using that particular component/engine to perform the action.

As mentioned above, the system is able to automatically extract information from documents using document classification engine 240, document segmentation engine 245, document conversion engine 220, information retrieval engine 225, and information extraction engine 230. Information may be extracted in various ways, depending on the type of document and the specific information needed. Documents may include pdf documents (e.g., filled pdf forms, pdf text documents (including tax return forms, insurance policy documents, and books), handwritten pdf documents, etc.), text documents, scanned images (e.g., of text documents, machine-printed documents, receipts, manually-filled out forms, and other handwritten documents, such as doctors' notes, etc.), program-generated images, audio and/or video recordings of phone and/or video calls, etc.

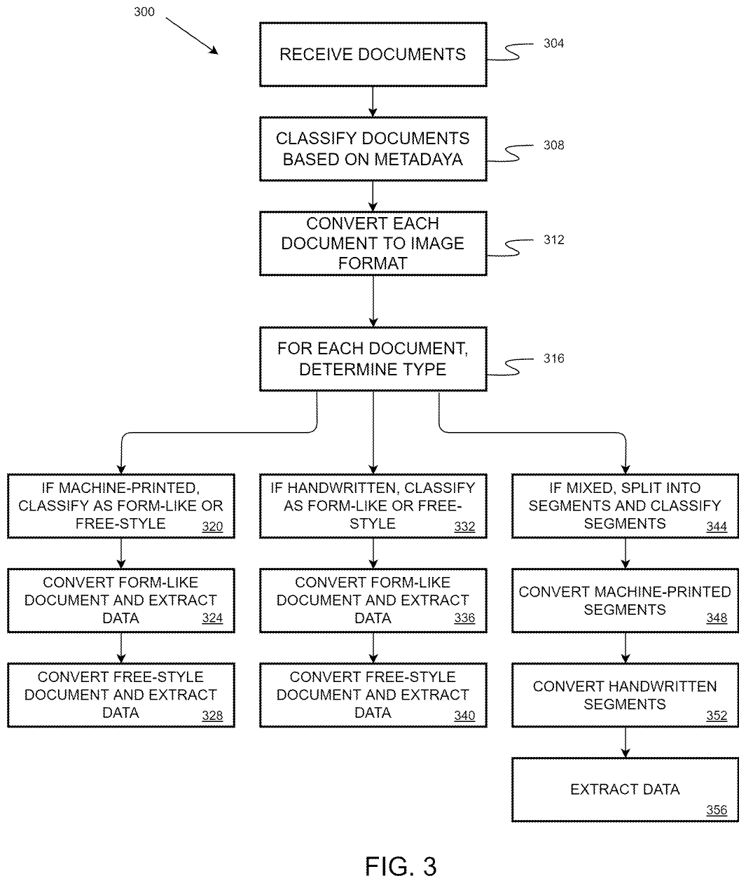

A method 300 for information extraction and/or retrieval is illustrated in FIG. 3. In step 304, a set of initial documents is received. The system also receives an indication of the information to be extracted from the document.

In step 308, the documents are classified based on document metadata or other associated info. Classes may include, but are not limited, to domain specific classes, such as medical documents, financial documents, etc. Classification may be performed by document classification engine 240.

In step 312, for each class of documents, each document in the class is converted into an image file format for further processing.

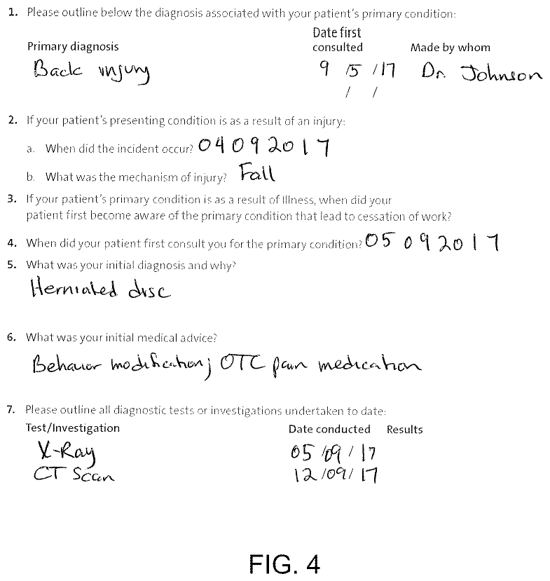

In step 316, each converted document is classified as (1) a machine-printed document, (2) a handwritten document, or (3) a mixed document, including both machine-printed segments and handwritten segments, such as a form (see FIG. 4). Such classification may be done by document classification engine 240 using a trained deep learning image classification model or other techniques as described herein.

In step 320, for machine-printed documents, the documents are classified as (1) form-like machine-printed documents, or (2) free-style machine-printed documents. Form-like documents are generally highly structured and have predictable positional relationships between descriptive text and data. Examples include tax returns, profit/loss statement, etc. Free-style documents are less structured or unstructured.

In step 324, the form-like machine-printed documents are converted to text and the needed data is extracted.

In step 328, the free-style machine-printed documents are converted to text and the needed data is extracted.

In step 332, for handwritten documents, the documents are classified as (1) form-like handwritten documents, or (2) free-style handwritten documents.

In step 336, the form-like handwritten documents are converted to text and the needed data is extracted.

In step 340, the free-style handwritten documents are converted to text and the needed data is extracted.

In step 344, for mixed documents, including both handwritten segments and machine-printed segments, the documents are split into segments (e.g., by document segmentation engine 245), and each segment is classified as machine-printed or handwritten (e.g., by document classification engine 240).

In step 348, the machine-printed segments are converted to text.

In step 352, the handwritten segments are converted to text.

In step 356, the segments are re-combined into a converted document with saved positional relationships, and the needed data is extracted from the combined machine-printed segments and handwritten segments.

Conversion of documents and segments to text is handled by the document conversion engine 220, using one or more OCR modules and/or handwriting recognition modules. For specific applications, custom OCR modules and/or handwriting recognition modules, that are specifically trained to better recognize field-specific terminology (e.g., tax field, insurance field), may be created and used.

Extraction of information from the retrieved and converted documents and/or segments is accomplished using natural language processing (NLP), including text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, transfer learning, question-and-answer methods, etc. The information extraction may be performed by information extraction engine 230.

As discussed herein, the system is able to automatically extract information from documents using document classification engine 240, document segmentation engine 245, document conversion engine 220, information retrieval engine 225, and information extraction engine 230. Information may be extracted in various ways, depending on the type of document and the specific information needed. Documents may include, but are not limited to, pdf documents (e.g., filled pdf forms, pdf text documents (including tax returns and insurance policy documents), handwritten pdf documents, etc.), text documents, scanned images (e.g., of text documents, machine-printed documents, receipts, manually-filled out forms, and other handwritten documents, such as doctors' notes, etc.), program-generated images, audio and/or video recordings of phone and/or video calls, etc.

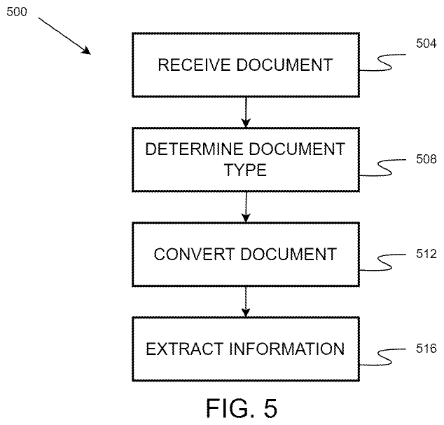

A method 500 for information extraction is illustrated in FIG. 5. In step 504, a document is received. Metadata regarding the type of document (with respect to its contents, e.g., the document is a financial document, medical documents, etc.) may also be received.

In step 508, the format of the document (e.g., pdf, image file, etc.) is determined based on the filename extension or other methods. This information is used by the document classification engine 240 to identify certain document metadata, e.g., document format, document field type, etc., which can then be used in document classification.

In step 512, the document is converted to text (e.g., by document conversion engine 220) using one or more techniques depending on its type. For example, pdf documents are converted to text and processed as a text document by the other engines. Some pdfs in standard format may be directly converted to text using a pdf conversion package. In an embodiment, standard pdf documents that include tables may first be segregated into table-containing parts and other parts (e.g., through identification of table-related tags), and the parts converted to text separately. The tables may be converted into a text table format (e.g., a CSV file) using a table conversion package.

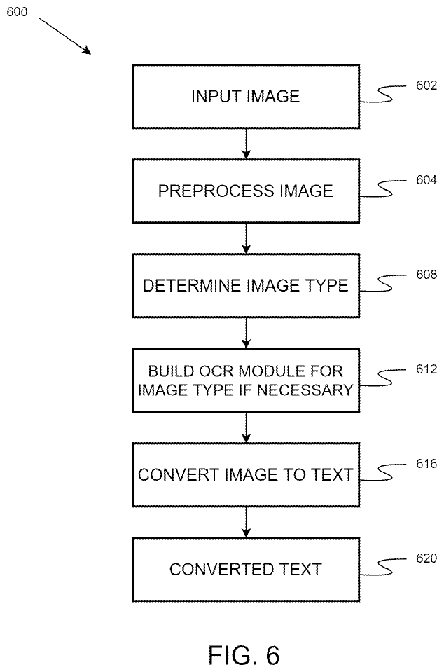

In cases where the pdf document is unable to be converted to text directly (e.g., the pdf does not follow pdf ISO or other standards, is a wrapper for images, etc.), the pdf may be transformed into one or more image files and processed as such. Conversion of image files is explained in more detail with respect to FIG. 6 below.

In step 516, the needed information is extracted from the document.

A method 600 for converting images of text (either handwritten or machine-printed) into text is illustrated in FIG. 6. Any image file format (e.g., jpeg, png, gif, bmp, tiff, etc.), including image file formats that will be created in the future, may be converted using this method.

In step 602, an input image is received.

In step 604, images that have sufficient clarity may be preprocessed, using techniques including skew correction, removal of black boxes, sharpening filters, enhancement of font and/or resolution, perspective transformation, noise removal, and/or morphological transformations (e.g., dilation, erosion, opening, closing, etc.) to better identify segments of text. Additionally, the blurriness of the images may be determined, and images that are too blurry to be processed further may be flagged for manual review.

In step 608, if not already determined, the type of image is determined, e.g., if the image is solely machine-printed text, solely handwritten text, or a combination. This classification may be performed by document classification engine 240. Alternatively, such classification may be performed manually.

Some documents with a combination of machine-printed text and handwritten text will be form-like documents, and these can be distinguished from other combination documents using heuristics or a trained machine learning model. One example of such a heuristic involves quantifying the spacing between the machine-printed text lines and the spacing between the handwritten lines. In a form-type hybrid document, the spaces between the machine-printed text lines are consistent or follow a pattern because the machine-printed questions are often equally spaced. Also, machine-printed text is usually of a consistent font size, so even if lines aren't equally spaced, the spacing is often approximately a multiple of a consistent line height. In contrast, spacing between handwritten lines is generally inconsistent.

In step 612, any needed OCR modules for the types of images can be built if necessary.

For example, a deep learning model for handwriting recognition can be trained. In an embodiment, this model may comprise a convolutional neural network (CNN) connected to a recurrent neural network (RNN), which is in turn connected to a connectionist temporal classification (CTC) scoring function.

Documents that include both machine-printed text and handwritten text, e.g., manually filled-out forms, are commonly used in many industries. Such forms often include a series of questions or other machine-printed labels for needed information, and spaces in which to write the supplied information. To automatically process such a form, the document classification engine 240 uses a text classifier that recognizes typed and handwritten text in a mixed image. In an embodiment, the classifier is a trained deep learning model that classifies text blocks into machine-printed text blocks and handwritten text blocks. In a particular embodiment, the deep learning model may comprise a convolutional recurrent neural network. The model may be trained on labeled printed and handwritten text blocks.

In an embodiment, an integrated OCR may be generated using the handwriting recognition model, the text classifier, and a machine-printed OCR module, which is able to process all the different types of text.

In step 616, the images are processed using one or more of the OCR modules to generate converted text 620. The resulting text can then be processed by the information extraction engine 230.

For the images that are converted to text format, positional relationships between the original image of the text and the converted text are also stored. For example, the original location of each text segment in the document may be stored (e.g., using the bounding box x and y coordinates) along with the converted text. This enables proximity and/or context information to be used by the information extraction engine when extracting needed information from the document.

In an embodiment, image files may be segmented into regions, and one or more regions of interest (ROI) can be selected. Then only the ROIs are converted to text to be used for information extraction.

If the image is unable to be converted to text, e.g., it is unreadable due to bad quality, it is overly blurry, etc., the document is flagged for manual processing. In an embodiment, the problematic portions of the image are highlighted.

After the document(s) is converted to text, the information extraction engine 230 uses

NLP techniques to extract the needed information. Such techniques may include text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, transfer learning, question and answering systems, etc.

For example, in an image document with form format, the words of the questions (or other labels) may be parsed using NLP techniques to identify where in the form the needed information may be found.

After the location of the question (or label) for the needed information is identified, the location of the answer is determined. This will generally in proximity to the question or label, e.g., for forms, it will generally be underneath the question (or label) or to the right of the question. The stored block locations (e.g., x and y coordinates) can be used to identify blocks of text in close proximity to the question or label, as such blocks are more likely to include the information for the data point. In some instances, the blocks containing a possible answer will be underlined, or surrounded by a box. The converted text of the blocks in proximity may then be analyzed to determine the value of the data point.

For example, if a date is required, e.g., the date of injury, the incurred date, the date of a doctor's diagnosis, etc., words indicating a date may be identified in the form. Such words include, for example, ‘date’, ‘when’, etc. The type of date may also be identified via keywords such as ‘injury’ for date of injury, etc.

After it is determined that the needed date is in the document, the actual information, e.g., the value for the date, is identified using NLP techniques. Because the context of each block of text is saved (e.g., its position in the document), the system can search for dates in nearby text. For example, text in date format near the words indicating the date may be identified and used as the value of the data point.

In an embodiment, prior to being analyzed by the information extraction engine, documents may be classified by category, e.g., medical documents, financial documents, employment documents, miscellaneous documents, etc. The specific type of document may also be determined, e.g., 1040 tax form, etc. NLP techniques tailored to the document category or type may be used to extract the required information from the documents.

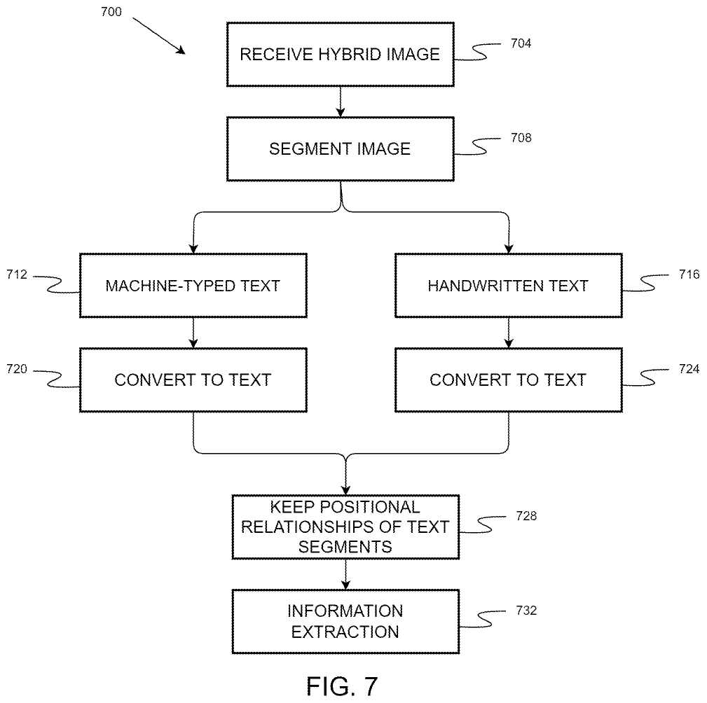

A method 700 for converting hybrid type-written and handwritten documents to text is illustrated in FIG. 7. In step 704, a hybrid document is received. In step 708, the document is divided in segments of machine-printed text 712 and handwritten text 716 using document segmentation engine 345. The original location of the segment in the document (e.g., the X/Y coordinates of the bounding box of the segment with respect to an origin point of the document) is also associated with each segment.

In step 720, each machine-printed text segment is converted into text format using OCR techniques.

In step 724, each handwritten text segment is converted into text format using a trained handwriting conversion model.

In step 728, the positional relationships of the segments with respect to each other is maintained, e.g., by replacing each segment in the document with the converted text to create a final document where all of the machine-printed and handwritten text has been converted to text and the text is in the same position as in the original document.

In step 732, any needed information is extracted from the converted document.

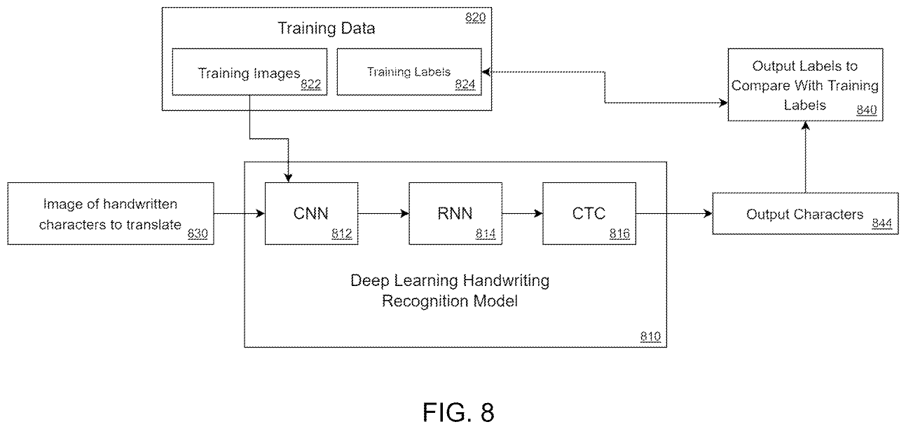

FIG. 8 illustrates an embodiment of a handwriting recognition model 810. This embodiment comprises a convolutional neural network (CNN) 812 connected to a recurrent neural network (RNN) 814, which is in turn connected to a connectionist temporal classifier (CTC) 816.

The model is trained using labeled training data 820, including training images of handwritten text 822 and labels for the training images 824. During training, the images are processed through the model 810, and then the output of the model 840 is compared with the training labels 824. The loss is then backpropagated through the network to tune the network weights. After the model is trained, an image 830, containing handwritten characters, may be processed through the model 810 to generate output characters 844.

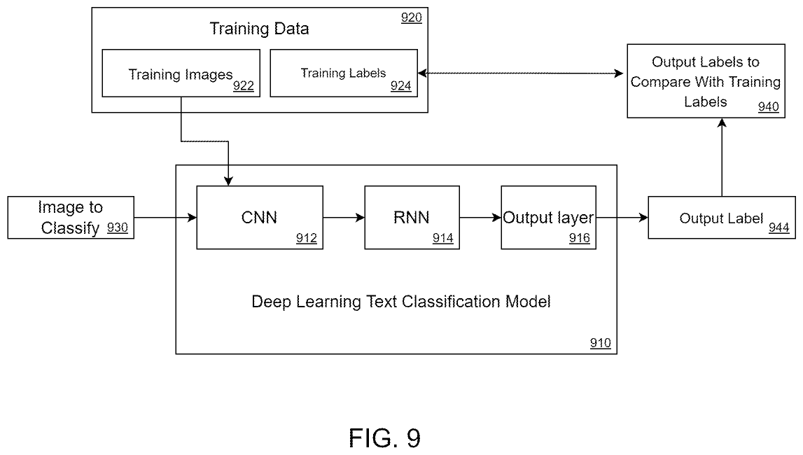

FIG. 9 illustrates an embodiment of the text classification model. This embodiment comprises a convolutional neural network (CNN) 912 connected to a recurrent neural network (RNN) 914, which is connected to an output layer 916, such as a Softmax layer.

The model is trained using labeled training data 920, including training images of handwritten and machine-printed text 922 that are labeled accordingly 924. During training, the images are processed through the model 910, and then the output of the model 940, e.g., whether the input image is handwritten or machine-printed, is compared with the training labels 924. The loss is then backpropagated through the network to tune the network weights. After the model is trained, an image 930, containing either a line of handwritten characters or a line of machine-printed characters, may be processed through the model 910 to be classified.

After the document(s) is converted to text, the information extraction engine 230 uses

NLP techniques to extract the needed information. Such techniques may include text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, transfer learning with pre-trained models, question and answer systems, etc.

For example, in an image document with a form-like format, the words of the questions or prompts may be parsed using NLP techniques to identify where in the form the needed information may be found.

After the location of the question or prompt for the needed information is identified, the location of the answer is determined. This will generally be in proximity to the question or prompt, e.g., for forms, it will generally be underneath the question or to the right of the question. Stored segment locations (e.g., x and y coordinates) can be used to identify segments of text in close proximity to the question, as such segments are more likely to include the information for the data point. In some instances, the segments containing a possible answer will be underlined, or surrounded by a box. The converted text of the segments in proximity to the question may then be analyzed to determine the value of the data point.

As a specific example, if a date is required, e.g., the date of injury, the incurred data, the date of a doctor's diagnosis, etc., words indicating a date may be identified in the form. Such words include, for example, ‘date’, ‘when’, etc. The type of date may also be identified via keywords such as ‘injury’ for date of injury, etc.

After it is determined that the needed date is in the document, the actual information, e.g., the value for the date, is identified using NLP techniques. Because the context of each segment of text is saved (e.g., its position in the document), the system can search for dates in nearby text. For example, text in date format near the words indicating the date may be identified and used as the value of the extracted variable.

A method for information retrieval and extraction using a question and answer framework is illustrated in FIG. 10. The method 1000 takes a predefined input question crafted for the required variable and a collection of text documents from which to extract the variable to answer the question. The method comprises four main phases: 1) query processing; 2) document retrieval; 3) passage retrieval; and 4) answer extraction, which leads to an output answer.

In step 1004, the input question is parsed to identify the most relevant keywords. The words of the question may be compared to a list of predefined keywords, and matches may be saved for further processing. Additionally and/or alternatively, the question may be processed by removing stop words and particular parts of speech, leaving only the most important words of the query. In an embodiment, only proper nouns, nouns, numbers, verbs, and adjectives are kept from the original query.

In step 1008, the modified query (e.g., the selected keywords from the query) is converted into a vector for use later in the process.

In step 1012, documents that may contain the answer to the original question are retrieved from the document store by information retrieval engine 225. In an embodiment, keyword matching between the query keywords and the words of the documents may be used to identify relevant documents, though other techniques for identifying relevant documents will be recognized by one of ordinary skill in the art.

In step 1016, the retrieved documents are segmented into passages (i.e., shorter sections of a document) for faster processing. This can be performed by a trained passage model or defined segmentation rules.

In step 1020, the passages are converted to vectors, similar to how the query is converted to a vector in step 1008.

In step 1024, the vectorized passages are compared to the vectorized query using cosine similarity or another similarity measure. The passage(s) with the highest similarity score(s), or the passages with a similarity score higher than a threshold score, may be selected for further processing in the next step.

In step 1028, each passage selected in the prior step is input into an answer extraction model, such as BERT (Bidirectional Encoder Representations from Transformers), ALBERT (A Lite BERT), ELECTRA, RoBERTa (Robustly Optimized BERT Pre-training Approach), XLNet, bio-BERT, a medical language model, etc., which gives the possible answers to the question, each with a corresponding confidence score. Then the answer with the highest score can be the final output 1032 of the method.

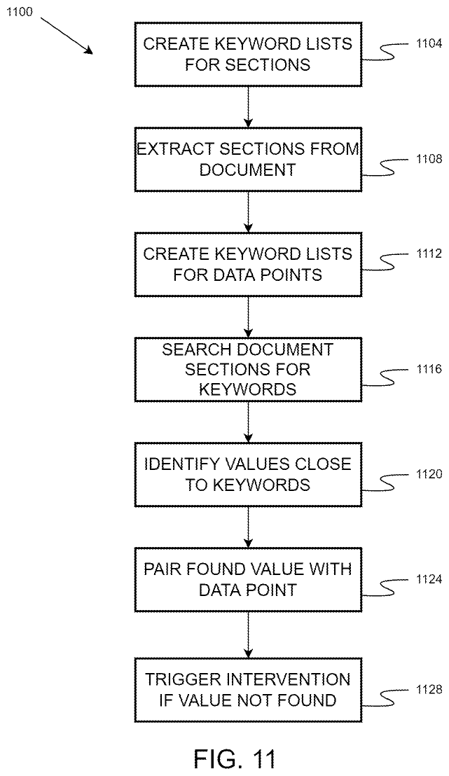

Certain information extraction methods are especially suitable for specific types of documents. An example method 1100 for extracting data from a converted form-like machine-printed document is illustrated in FIG. 11. Many financial documents (e.g., paystubs, profit and loss statements, tax returns, etc.) fall into this category. Financial documents tend to have a fixed structure and format, so this method works well for such documents. A keyword list is generated that includes keywords that indicate the potential presence of the data for the required variable. The keyword list may also include one or more specific positions where that keyword may be found in a particular type of document, such as a tax form, and the relative positioning of the value for the data point as compared to the position of the keyword. For example, in a particular tax form, the filer's income will typically be proximate to, or in a known positional relationship from, the keyword “income.” As such, the keyword list may include “income”, as well as the expected position in the document of the keyword, and the expected position in the document for the corresponding income value. Keyword lists may be created for each needed variable. Keyword lists may also be created to identify relevant sections of the document.

In step 1104, keyword lists that identify relevant sections of the document are created.

For example, the keyword “deductions” may be a relevant keyword for a section of a tax return that deals with deductions to income.

In step 1108, the relevant sections of the document are identified using the keyword list created in the prior step.

In step 1112, keyword lists are created for each needed financial variable. The expected positional relationship between the keyword(s) and the data for the variable are identified as well.

In step 1116, the document text is searched for the keywords in the list.

In step 1120, document text in proximity to the keywords is searched for possible values for the associated data point. Proximity is determined based on the position information that is saved during the conversion of the document to text. Financial documents tend to have a fixed format, so if a keyword is found in a particular expected position in the document, the corresponding value for the data point associated with the keyword may also be located using the expected positional relationship (as determined in step 1112) between the keyword and the corresponding value.

In step 1124, if a single value is found in the previous step, it is saved as the value for the data point variable.

In step 1128, if a single value was not found, human intervention is triggered to determine the value for the data point. If multiple possible values for the data point were found in step 1120, the values may be presented to a person for selection of the correct value.

Though this method is especially suitable for financial documents, this method can be used for extracting information from other types of documents, including medical documents, miscellaneous documents, etc., that have predictable relationships between keywords and specific required data.

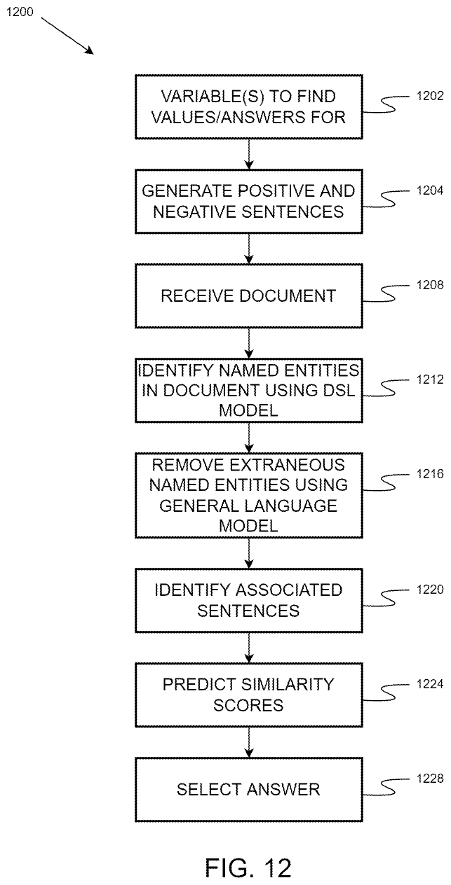

A method 1200 for information retrieval and/or extraction of information from a machine-printed free-style document is illustrated in FIG. 12. A use case of extraction of information about a particular injury or illness is illustrated, but the same method is applicable to extraction of other types of data.

Method 1200 starts by receiving a variable or variables for which a value needs to be found in step 1202. For example, the variable may be whether or not the patient had a heart attack.

The method continues by creating both positive and negative sentences relating to the variable in step 1204. For example, continuing the example of a variable regarding a heart attack, the sentences can be “the patient had a heart attack” or “the patient didn't have a heart attack.” Variations on the sentences can also be created, e.g,, “the man/woman had a heart attack”, “the patient is having a heart attack”, etc.

In step 1208, a machine-printed document is received and converted to text using one or more conversion techniques as described herein. In an embodiment, a custom OCR module may be used or generated that is specifically trained to recognize the words or language used in the applicable field, e.g., in the illustrated use case of illness and/or injury, the custom OCR module may be trained to better recognize illness and injury words and/or phrases. Alternatively, the document may have been converted to text prior to the start of the method.

In step 1212, a pre-trained domain specific language (DSL) named entity recognition (NER) model (e.g., a medical NER model) is used to identify words in the document that relate to a known named medical-related term. This step can return many irrelevant results, such as proper names and places, so in step 1216, a pre-trained general NER model is used to remove these irrelevant results, leaving only the specific medical terms recognized by the medical NER model but not recognized by the general NER.

In step 1220, the complete sentences that contain the words identified in steps 1212 and 1216 are extracted from the document using NLP techniques.

In step 1224, similarity scores between the sentences created in step 1204 and the sentences extracted from the document are created using the method disclosed in FIG. 10.

In step 1228, based on the similarity scores and predefined criteria based on “ground truth” results, a sentence from the document is selected as the answer. In an embodiment, the sentence with the highest similarity score may be selected, though other criteria may also be used. If the selected sentence is most similar to the positive sentence, then the claimant has or had the condition. If the selected sentence is most similar to the negative sentence, then the claimant does not have or did not have the condition. This result is then saved for further processing according to the methods disclosed herein. If the method is unable to identify a sentence from the document that meets the predefined criteria (e.g., no sentence has a high enough similarity score), the system prompts for human intervention.

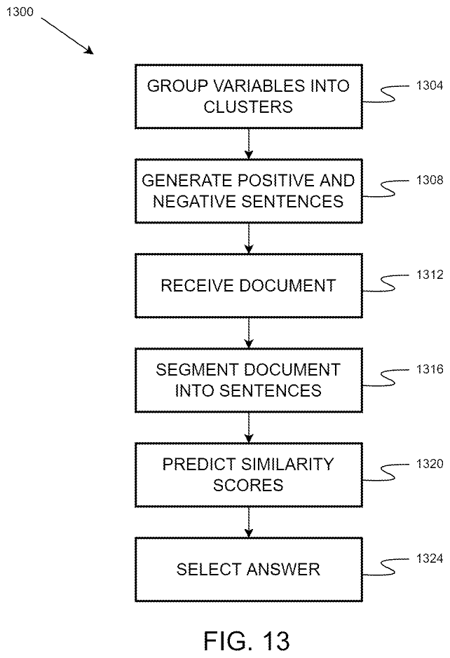

Another method for information retrieval and/or extraction from machine-printed free-style documents, this one useful for extracting the answers to more general questions, is illustrated in FIG. 13. A use case of extraction of information about a claimant being capable of performing work is illustrated, but the same method is applicable to extraction of other types of data.

Method 1300 starts by clustering data points or variables into clusters of similar data points in step 1304. For example, all of the work-related data points, such as if the claimant is capable of work in his/her field, if the claimant is capable of any work, etc., can be grouped into a single cluster.

Positive and negative sentences related to the data point cluster are created in step 1308. For example, if the specific data point being searched for is a whether the claimant is capable of work, the sentences can be “the patient is capable of work” or “the patient isn't capable of work.” Variations on the sentences can also be created, e.g,, “the man/woman is capable of work”, “the patient wasn't capable of work”, etc.

In step 1312, a medical document is received and converted to text using OCR techniques. In an embodiment, a custom OCR module may be used or generated that is specifically trained to recognize the words or language used in the applicable field, e.g., in the illustrated use case of work capability, the custom OCR module may be trained to better recognize words and/or phrases related to working and/or a person's capability to work. Alternatively, the document may have been converted to text prior to the start of the method.

In step 1316, the document is segmented into sentences, e.g., using segmentation engine 245.

In step 1320, similarity scores between the sentences created in step 1308 and the document sentences are created using the method disclosed in FIG. 10.

In step 1324, based on the similarity scores and predefined criteria based on “ground truth” results, a sentence from the document is selected as the answer. In an embodiment, the sentence with the highest similarity score may be selected, though other criteria may also be used. If the selected sentence is most similar to the positive sentence, then the claimant has or had the condition. If the selected sentence is most similar to the negative sentence, then the claimant does not have or did not have the condition. This result is then saved for further processing according to the methods disclosed herein. If the method is unable to identify a sentence from the document that meets the predefined criteria (e.g., no sentence has a high enough similarity score), the system prompts for human intervention.

While FIGS. 11 through 13 are specifically directed to information extraction from machine-printed documents, information can be extracted from handwritten documents, both form-like and free-style, in similar ways.

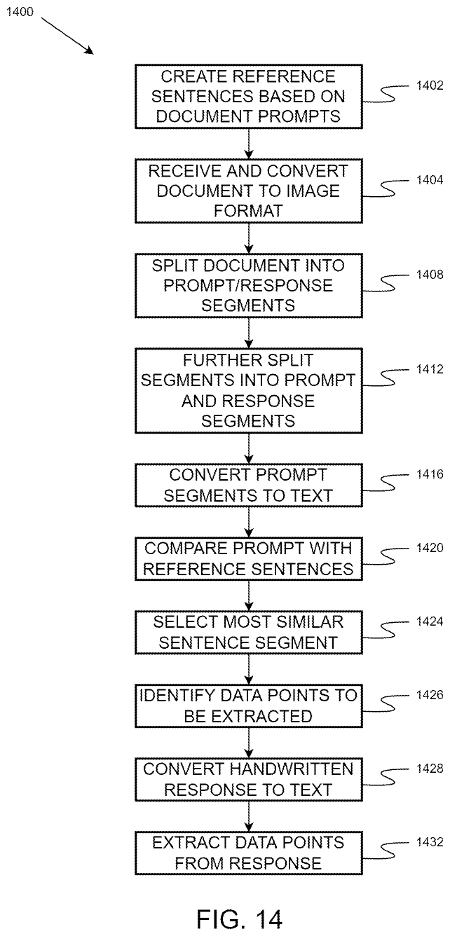

Information can also be extracted from mixed or hybrid documents, i.e., documents that include both handwritten and machine-printed text. An example method 1400 for extracting information from mixed documents is illustrated in FIG. 14. Mixed documents are often in a form-like format (as illustrated in FIG. 4) with machine-printed questions (e.g., “When did the incident occur?”) or sentences (e.g., “Please outline below the diagnosis associated with your patent's primary condition”), and handwritten responses. The questions or sentences will be referred to herein as “prompts.” One of ordinary skill in the art will recognize that each prompt may be less than a complete question or sentence, including, e.g., single words (e.g., “Name”, “Age”, etc.), numbers or letters followed by zero or more punctuation marks (e.g., “1)”, “a:”, “A”, etc.). A such, a prompt includes any number of machine-printed characters or symbols that indicate what information should be included in the response and where it should be put in the document.

There is typically a space proximate to (e.g., above, below, next to, etc.) the machine-printed prompts for the handwritten responses. The predictability of the layout of a form-like document can be used to divide the document into segments that include one prompt and the corresponding response.

Similar to some of the other methods disclosed herein, this method uses a sentence similarity calculation to match prompts with data points. As such, in step 1402, a set of reference sentences that match the prompts in the document is created. Each reference sentence is associated with the data points that relate to the information that would normally be found in the response. For example, if the document prompt is “Patient's Name:”, the reference sentence “Patient's Name” could be created, and that reference sentence could be associated with a data point for the patient's name.

In step 1404, a mixed document is received and converted to an image format as described elsewhere herein. In step 1408, the document is segmented into individual prompt and response segments. The segments can be determined in several ways, including using a machine learning model trained to identify segments, identification of image features, predetermined boundaries based on prior analysis of the document, etc. Image features that could identify segment boundaries include, but are not limited to: the vertical distance between rows of machine-printed text; the x-coordinate for the 1^{st} character in a row (to identify level of indentation, etc.); amount of empty space between individual words in a row (to identify tabs, etc.); x-coordinates of titles and sub-titles; and any combination thereof. One of ordinary skill in the art will recognize other image features that identify segments, and all such features are within the scope of this disclosure.

In step 1412, each prompt/response segment is further segmented into a machine-printed prompt part and a handwritten response part. The prompt and response segments can be determined in several ways, including using a machine learning model trained to identify segments (e.g., a ML classification model that classifies pixels or pixel clusters as handwritten or machine-printed, etc.), identification of image features, predetermined boundaries based on prior analysis of the document, etc. Image features that could identify prompt and response segment boundaries include, but are not limited to: the amount of horizontal empty space (for segmenting responses that are written a specific horizontal distance from the prompt); x-coordinates of column headings (for segmenting responses that are in columns with a heading); and any combination thereof. One of ordinary skill in the art will recognize other image features that identify segments, and all such features are within the scope of this disclosure.

If the handwritten response is in columns (e.g., with machine-printed headings or labels), then the handwritten response segment is further subdivided into individual column segments. The dividing lines between the handwritten columns may be based on the starting and ending x-positions of the machine-printed column headings, e.g., each handwritten column is defined between the starting x-position of its column heading and the starting x-position of the next column's heading. Alternatively, each handwritten column may be defined between the starting x-position of its column heading and the ending x-position of its column heading. Which definition (or other alternatives) is used depends on the layout of the individual document.

In step 1416, each prompt segment is converted into text using one or more of the techniques described herein for conversion of machine-printed text to text format.

In step 1420, an extracted prompt is selected and the set of reference sentences is compared with the extracted prompt. Each reference sentence is compared with the selected prompt using NLP sentence similarity, e.g., a cosine similarity function or similar.

In step 1424, a reference sentence is selected as the most similar to the selected prompt.

For example, the reference sentence with the highest similarity score to the prompt may be selected.

In step 1426, based on the selected reference sentence, data points that can be extracted from the response are identified. The data points are identified based on the associations between reference questions and data points previously determined in step 1402.

In step 1428, the handwritten response corresponding to the selected prompt is converted to text.

In step 1432, the associated data points are extracted from the response. In an embodiment, predefined extraction rules can be created for each associated data point, identifying where the data point may be located, and how much space it occupies, relative to the prompt in the segment and/or document. For example, the response may be located below the prompt and occupy the equivalent of two lines of machine-printed text, or the response may be located next to the sentence and occupy the remainder of the line of text of the sentence.

Steps 1420 through 1432 may be repeated as necessary to extract information from all prompts in the document. This method may be used to extract information from any form-like document, including medical, financial, and other documents.

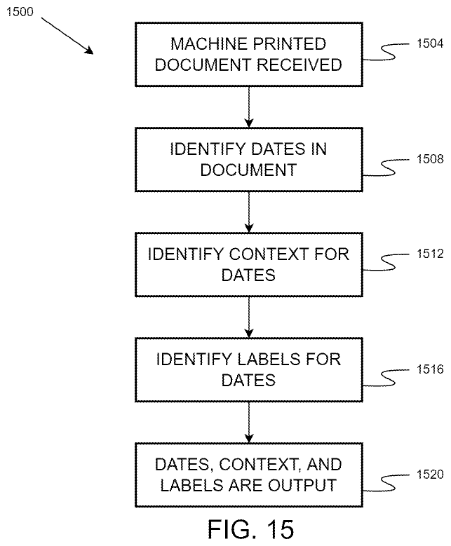

Dates are a specific example of a type of data that can be extracted in various ways from documents. An example method 1500 for extracting dates and their contexts and labels from machine-printed documents is illustrated in FIG. 15. In step 1504, a machine-printed document is received.

In step 1508, all dates are identified in the document using natural language processing techniques. For example, pattern matching can be used to identify dates that follow a particular pattern, such as “MM/DD/YY”, “DD/MM/YY”, “DD/MM/YYYY”, etc.

In step 1512, the context of the date in the document is identified. The context is a defined number of words, sentences, and/or characters before and/or after the location of the date in the document.

In step 1516, the date context is searched to determine labels associated with the date.

For example, NLP techniques may be used to identify possible labels with the word “date” in them, e.g., “doctor-visit-date”, “surgery date”, etc.

In step 1520, the date, the date context, and the date labels are output as the results of the method.

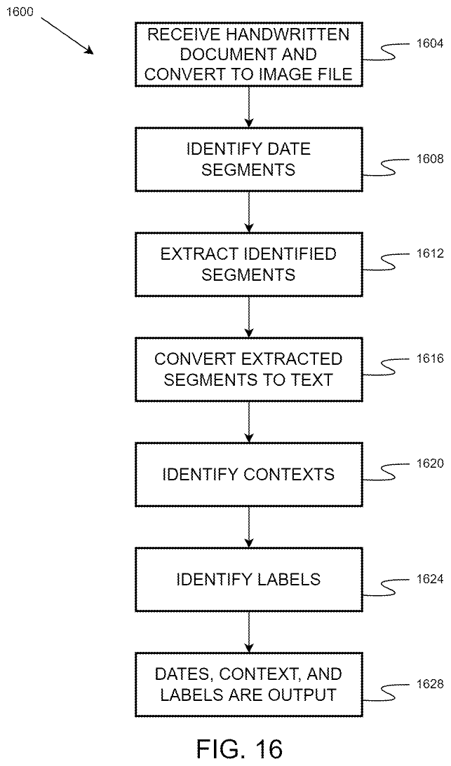

Dates and their contexts can also be identified in handwritten documents, as illustrated by method 1600 in FIG. 16. In step 1604, a handwritten document is received and converted to an image file.

In step 1608, a trained machine-learning model is used to identify segments of the document that include, or primarily consist of, a date. The date-identification model may take into consideration the length and width of the segment to determine if a date is present in the segment.

In step 1612, the document segments identified in the previous step are extracted from the document.

In step 1616, a trained handwriting recognition model is used to convert the extracted segments into text. This model may be a open source handwriting recognition model, or a model specifically trained to identify dates.

In step 1620, the contexts of the dates in the document are identified. The context is a defined number of words, sentences, and/or characters before and/or after the location of the date in the document.

In step 1624, the date contexts are searched to determine labels associated with the dates.

For example, NLP techniques may be used to identify possible labels with the word “date” in them, e.g., “doctor-visit-date”, “surgery date”, etc.

In step 1628, the dates, the date contexts, and the date labels are output as the results of the method.

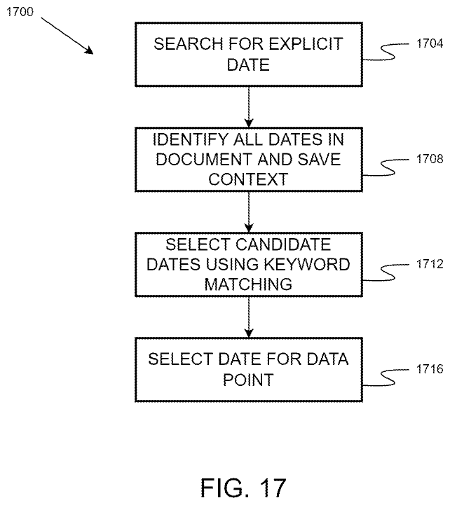

FIG. 17 illustrates a method for finding a particular type of date (e.g., date of injury) from a set of extracted dates and their respective contexts and labels. The date(s) found using this method may be used as extracted variable(s) in other methods.

In step 1704, a set of keywords that identify the type of date to be searched for, and a set of extracted dates and their respective contexts and labels, are received.

In step 1708, for each date in the set of extracted dates, the set of keywords associated is compared with the textual context and labels of the date, and the dates that match a minimum number of the keywords are kept as candidate dates.

In step 1712, one date is selected from the candidate dates as the value for the extracted variable. Each date in the candidate date list is checked using one or more pre-defined rules to determine if it should be selected. For example, when initiating a total or partial disability claim, the claimant will have entered a date when he or she ceased work, but this date is not verified or supported by medical evidence at this point. If any date in the candidate list matches the previously entered date, it will be selected as the best candidate date. Some important variables, such as the incurred date for an insurance claim, will always undergo manual review.

These methods can be used to extract date information from any type of document, including financial documents, medical documents, miscellaneous documents, etc.

Any information extracted from a document using any of the techniques disclosed herein may be associated with a date, e.g., the date of the document, so that the extracted information can be considered valid for only a specific date period. For example, if the extracted information shows that a person is under a medical treatment (such as depression treatment), the start and end dates associated with the treatment are also needed. Otherwise (e.g., in insurance cases) the system cannot determine if the treatment is covered under the current claim.

### Use Cases

The disclosed systems and method for information retrieval and information extraction may be used in a variety of industries. One use case for the insurance industry is extracting insurance policy rules, conditions, data points, and/or formulae from insurance policy documents, assessing entitled benefits, and calculating benefit amounts.

Insurance policy documents are typically machine-printed text documents, such as pdf files. As such, they are readily converted to text using the techniques described herein. Furthermore, insurance policy documents usually have identifiable section headings and/or a table of contents, so the policies are able to be segregated based on the chapter titles and/or section headings. For example, if the policy document includes sections with headings including the terms “Total disability” and “Partial disability,” the system segregates the policy document based on those headings.

After the policy document is segregated, the individual sections may be processed using the information extraction techniques described herein. Through these techniques, all benefit items are extracted for each policy. Then, for each benefit item, the following are extracted: 1) benefit conditions in order to qualify for the benefit; 2) data points that define the benefit items; and 3) the actual benefits, e.g., a monetary amount specified in the policy document, a monetary amount calculation formula, variables, and/or non-monetary benefits.

For example, an example policy clause may read:
We will pay up to $100 per day for up to 90 days for each day the immediate family member has to stay away from home after the end of the waiting period.

The system uses the NLP techniques to parse this clause to identify several important data points, including: 1) per diem amount (e.g., $100); 2) maximum time period (e.g., 90 days); 3) qualified payee (e.g., immediate family member); and 4) qualified action (e.g., stay away from home).

In another example, the text of the policy document may recite:
The person insured is totally disabled if, because of an injury or sickness, he or she is: 1) not capable of doing the important duties of his or her occupation; 2) not working in any occupation (whether paid or unpaid); and 3) under medical care.

The uses the NLP techniques to parse this clause and determine 4 requirements for a benefit: 1) the claimant is not capable of doing the important duties of his or her occupation; 2) this condition is because of an injury or sickness; 3) the claimant is not working in any occupation; and 4) the claimant is under medical care.

For example, the system can determine that the requirement of “injury or sickness” exists because of the presence of the keywords “injury” and/or “sickness” in the clause. Similarly, “under medical care” indicates the requirement of being under medical care, “not working” indicates the requirement of not working in any occupation, and “not capable” indicates the requirement of not being capable of doing the important duties of his or her occupation.

Another use case is comparison of insurance policies and identification of similar insurance policies. After the benefit information (e.g., benefit conditions, data points, actual benefits, etc.) are extracted from the insurance policy documents, the benefit information of two policies may be compared. Both the extracted structured information and the policy text itself may be compared to make a determination as to how similar the policies are. The policy text may be compared using NLP similarity techniques (e.g., cosine similarity, etc.). Comparisons between an original policy and several alternative polices may be calculated to determine a closest match.

Another use case for the insurance industry is the extraction of information from insurance claim documents. Claim documents may include pdf documents (e.g., filled pdf forms, pdf text documents (including tax returns and policy documents), handwritten pdf documents, etc.), text documents, scanned images (e.g., of text documents, machine-printed documents, receipts, manually-filled out forms, and other handwritten documents, such as doctors' notes, etc.) and/or program-generated images. Such documents may be converted to text using the methods described herein, and then processed using NLP information extraction techniques.

For each claim, there are questions that need to be answered in order to process the claim, e.g., “what is the incurred date?” and “is the claimant under medical care?” The answers to these questions can be automatically extracted from applicable claim documents.

The first step in answering a question is to identify the types of documents that may include an answer to the question. For example, for the “what is the incurred date?” question, relevant documents may include claim forms, doctors' medical opinions, clinical notes, transcripts of phone calls regarding the claim, transcripts of phone calls with the employer, etc.

After the documents that may answer the question are identified, the system then processes each document using NLP techniques to determine if the question is answered in the document. In an embodiment, NLP techniques are used to determine if the subject of the question is discussed in the document.

For example, in a form, the words of the questions (or other labels) may be parsed using

NLP techniques to identify where in the form the needed information may be found. If a date is required, e.g., the incurred date, the date of a doctor's diagnosis, etc., words indicating a date may be identified in the form. Such words include, for example, ‘date’, ‘when’, etc. The type of date may also be identified via keywords such as ‘injury’ for date of injury, ‘incurred’ for incurred date, etc.

If it is determined that the subject of the question is discussed in the document, the answer to the question is identified using NLP techniques. Because the context of each block of text is saved (e.g., its position in the document), the system can search for answers to the question in nearby text. For example, if the answer to the question is a date, text in date format near the words indicating the date may be identified and used as the answer to the questions.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a non-transitory medium for execution by a data processing apparatus. The computer storage medium can be one or more of: a machine-readable storage device, a machine-readable storage substrate, a random or serial access memory device, and combinations thereof.

As used herein, the term “data processing apparatus” comprises all kinds of apparatuses, devices, and machines for processing data, including but not limited to, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any programming language, and it can be deployed in any form, including as a standalone program or as a module, component, subroutine, or other unit suitable for use in a computing environment. A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”).

Computer readable media suitable for storing computer program instructions and data include all forms of nonvolatile memory, media, and memory devices. For example, computer readable media may include one or more of the following: semiconductor memory devices, such as ROM or RAM; flash memory devices; magnetic disks; magneto optical disks; and/or CD-ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors, and/or organic light-emitting diode (“OLED”) monitors. The computer may further comprise one or more input devices by which the user can provide input to the computer. Input devices may comprise one or more of: keyboards, pointing devices (e.g., mice, trackballs, etc.), and/or touch screens. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers, including servers managing a web API. The client and server may be remote from each other and interact through a communication network. The relationship of client and server arises by virtue of computer programs running on the respective computers and having a client-server relationship to each other.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A computer-implemented method for extracting information from a set of computer-readable digital documents, comprising:
classifying the documents into different domain classes;
converting the digital documents to an image format;
classifying each document as machine-printed, handwritten, or mixed;
classifying each machine-printed or handwritten document as form-like or free-style;
converting at least a portion of each document into a digital text format using one or more of a trained machine learning model and an optical character recognition algorithm, the conversion based on the document classification; and
extracting information from the set of converted documents.

2. The method of claim 1, wherein the classifying the documents into different domain classes is based on document metadata.

3. The method of claim 1, wherein the classifying as machine-printed, handwritten, or mixed is performed by a trained machine learning algorithm.

4. The method of claim 1, wherein the classifying as form-like or free-style is performed by a trained machine learning algorithm.

5. The method of claim 1, wherein the conversion of machine-printed documents to text comprises using an optical character recognition algorithm.

6. The method of claim 1, wherein the conversion of handwritten documents to text comprises using a trained machine learning model.

7. The method of claim 1, wherein the conversion of a mixed document comprises:
splitting an original mixed document into segments, wherein each segment is handwritten or machine-printed;
converting the machine-printed segments to text;
converting the handwritten segments to text; and
combining the segments to create a converted mixed document, wherein the positional relationships between the segments of the original mixed document are maintained in the converted mixed document.

8. The method of claim 7, wherein splitting the original mixed document into handwritten and machine-printed segments comprises using a trained machine learning model.

9. The method of claim 7, wherein the conversion of machine-printed segments to text comprises using an optical character recognition algorithm.

10. The method of claim 7, wherein the conversion of handwritten segments to text comprises using a trained machine learning model.

11. The method of claim 7, further comprising the step of storing the bounding box of each segment.

12. The method of claim 1, wherein extracting the information comprises generating a confidence score with respect to the extracted information.

13. The method of claim 12, wherein extracting the information comprises signaling for manual intervention when the confidence score is lower than a threshold.

14. The method of claim 1, wherein extracting the information comprises using a question and answering method wherein the questions are generated based on a data point, and wherein the questions include both positive and negative sentences.

15. The method of claim 14, wherein the question and answering method is configured to perform the following steps:
receiving a question;
extracting keywords from the question;
converting the extracted keywords to a vector;
identifying relevant documents in the set of converted documents based on the extracted keywords;
splitting the relevant documents into passages;
vectorizing the passages;
comparing the vectorized question keywords to the vectorized passages to determine the passages that are the most similar to the question; and
using a language model to extract the answer from the most similar passage based on the question keywords.

16. The method of claim 15, wherein the vectorized question keywords is compared to the vectorized passages using a cosine similarity metric.

17. The method of claim 15, wherein the language model comprises BERT, ALBERT, ELECTRA, RoBERTa, XLNet, bio-BERT, or a medical language model.

18. The method of claim 1, wherein the information comprises a value for a data point, and extracting the information comprises:
creating a keyword list for identifying at least one section of a document;
creating a keyword list for identifying at least one value in a document corresponding to the data point;
extracting at least one section from a document selected from the set of converted documents based on the section keyword list;
identifying at least one value in the selected document based on the value keyword list;
extracting the identified value from the selected document and assigning it to the data point; and
triggering manual intervention when a value for the data point cannot be determined.

19. The method of claim 1, wherein the information comprises a value for a data point, and extracting the information comprises:
generating at least one positive sentence and at least one negative sentence based on the data point;
identifying at least one named entity related to the data point in a document selected from the set of converted documents using a named entity recognition model;
extracting at least one sentence containing at least one name entity;
generating similarity scores between the generated sentences and the extracted sentences;
selecting an extracted sentence based at least in part on the generated similarity scores;
determining the value for the data point based on the selected sentence; and
triggering manual intervention when a value for the data point cannot be determined.

20. The method of claim 1, wherein the information comprises a value for a cluster of data points, and extracting the information comprises:
generating a data point cluster based on a set of data points;
generating at least one positive sentence and at least one negative sentence based on the data point cluster;
segmenting a document selected from the set of converted documents into sentence segments;
generating similarity scores between the generated sentences and the sentence segments;
selecting a sentence segment based at least in part on the generated similarity scores;
determining the value for the data point cluster based on the selected sentence; and
triggering manual intervention when a value for the data point cluster cannot be determined.

21. The method of claim 1, wherein the information comprises a value for a data point and the information is extracted from a form-like mixed document, wherein the document comprises pairs of prompts and responses, and further wherein extracting the information comprises:
generating reference sentences based on the document prompts;
associating at least one reference sentence with the data point;
splitting the mixed document into segments, wherein each segment comprises a machine-printed prompt and a handwritten response;
further splitting the segments into prompt segments and response segments;
converting the prompt segments into text;
generating similarity scores between the reference sentences and the converted prompt segments;
selecting a prompt segment based at least in part on the generated similarity scores;
determining the value for the data point based on the selected prompt segment; and
triggering manual intervention when a value for the data point cannot be determined.

22. The method of claim 1, wherein the information comprises a date value, and extracting the information comprises:
identifying all dates in a document selected from the set of documents;
extracting the identified dates and the context of each date from the document;
converting the extracted dates and contexts into text format;
identifying at least one date label from each converted date context;
searching the date labels and contexts for keywords from a previously generated set of keywords related to the date value to generate a set of candidate dates; and
selected a single date from the candidate dates based on a set of pre-defined rules.

23. A computer-implemented method for extracting information from a form-like mixed document, the document comprising pairs of prompts and responses, the method comprising:
generating reference sentences based on the document prompts;
associating each reference sentence with one or more data points;
splitting the mixed document into segments, wherein each segment comprises a machine-printed prompt and a handwritten response;
further splitting the segments into prompt segments and response segments;
converting the prompt segments into text;
generating similarity scores between the reference sentences and the converted prompt segments; and
determining the value for at least one of the one or more data points based at least in part on the similarity scores and the associations between the reference sentences and the one or more data points.
